(19) United States
(12) Patent Application Publication
(10) Pub. No.: US 2010/0299588 A1
(43) Pub. Date: Nov. 25, 2010

(54) METHOD AND SYSTEM FOR PROVIDING INTERACTION BETWEEN A HOST SYSTEM AND WEB PAGES

(76) Inventors: Michael Joseph Dattilo, Winchester, KY (US); Joseph Aaron Hatfield, Georgetown, KY (US); Thomas Jefferson Hubbell, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/469,993

(22) Filed: May 21, 2009

(51) Int. Cl. G06F 17/00; G06F 3/048

(52) U.S. Cl. 715/234; 715/760

(57) ABSTRACT

A method and a system for providing interaction between a host system and a plurality of web pages in a Wide Area Network are disclosed. The method includes receiving a request from a web page for information of a peripheral device present at the host system. The method further includes creating an iframe element of the web page. The iframe element includes a Uniform Resource Indicator (URI) of an actual script file for the web page. Further, the method includes extracting a serialized form of the request based on a navigation event corresponding to the iframe element of the web page. The navigation event is triggered by a web browser of the host system. The method further includes generating a response attribute corresponding to the request based on the serialized form of the request. Thereafter, the method includes providing the response attribute to the iframe element of the web page.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates to Wide Area Network, and more particularly, to providing interaction between a host system and web pages in the Wide Area Network.

2. Description of the Related Art

World Wide Web (WWW), generally referred as “web”, and web browsers (or browsers) are the most necessary tools for accessing web pages on local systems, such as host systems. A web browser at a typical host system may display web pages and can navigate from one web page to another web page on the web. Generally, millions of web pages are viewed everyday and some web pages may be required to be used by peripheral devices present at the host system. An example of such use may be printing of the web pages by a peripheral device such as a printer present at the host system. However, web browsers provide only basic support for printing of the web pages. The web pages, when accessed by the web browsers, are optimized to fit within a flexible and scrolling windowed environment. Further, the web pages are not optimized for fixed dimensions of the printer media such as a printer paper.

Typically, due to non-optimization of the web pages with the printer paper, the web pages may not be adjusted to the size of the printer paper. Due to this, printing of the web pages typically leads to undesirable results such as clipped text, missing content, undesired headers/footers, and usage of extra pages of printer paper that are mostly blank. For example, if a web page is too wide to fit on one page of printer paper, printing of the web page usually results in wastage of the printer paper, for instance, in the form of an unwanted stripe of ink color on the paper. Further, after the printing of the web page on the printer paper, the printer paper may contain unwanted matter from the web page, such as banner ads, logos, and the like. Furthermore, most of the required material of the web page, such as text and pictures, may require extra printer paper for printing. Thus, non-optimization of the web page with the printer paper leads to wastage of the printer paper and ink/toner of the printer, and hence results into a poor and an inefficient print operation.

Additionally, a few ways are available that provide corrective print operation. For example, some web sites provide a remedy for the problem of inefficient printing by providing a link for printer friendly version of their web pages. However, to obtain this remedy, a user needs to download a completely new page to get the printer friendly version of the web pages. Moreover, as the printer friendly version is provided on only some web sites, the user may not try to find the link for the printer friendly version and may not otherwise notice such a link. Furthermore, a web designer needs to design a completely new page for content of the web pages for developing a printer friendly version of the web pages. Thus, for printer friendly version, plenty of heavy work and a considerable amount of time are required.

Various technologies, such as client side technologies of a client side and server side technologies of a web server have been used to utilize computing power of a client computer, web browser and a web server. Herein, term ‘client side’ refers to the host system. The client side technologies may include, but are not restricted to, Hypertext Markup Language (HTML), Cascading Style Sheets (CSS), JavaScript and Flash. The server side technologies utilize the web server for transforming data or images into a client side format, such as HTML and JavaScript that can then be displayed (as web page) by the web browser. Accordingly, a typical web page may employ a mixture of the client side and the server side technologies to present information to the user.

Further, the client side technologies, such as HTML, and CSS may be used to position text, images and other elements of the web pages for printing. Also, CSS may be used to specify a distinct presentation of the web pages for printing the web pages. However, when a user prints the web pages, a separate style sheet may be called to alter the design for the printer paper. Furthermore, the server side technologies that are specifically used for printing purposes pre-format data into fixed size formats (such as an image file or an Adobe Portable Document Format (PDF) file) that are more acceptable to printers for printing the web pages, For example, the “Tabblo Print Toolkit” by Hewlett-Packard® contains a layout engine that can generate a PDF file on the web server.

However, the existing ways of printing the web page through various technologies, specifically the server side technologies, (hereinafter referred to as “web printing technologies”) are not completely integrated with the web browser and provide only minimal improvement over existing problems, such as wastage of the printer paper, ink/toner of the printer, in the printing of the web page. Further, the web printing technologies do not provide ways for the web pages to query about basic information about available printer(s) on the host system.

Typically, client side applications (that may be developed by using the client side technologies) that are not web-based, have access to printer capabilities through an Operating System (OS) of the host system. For example, the Windows® OS has a Graphics Device Interface (GDI) subsystem that maintains printer capabilities and states, such as size of the printer paper that is supported by the printer, driver name for the printer, online status and printing status of the printer. Due to this, every Windows® application (the client side application) can make use of the GDI subsystem to provide a basic rendering of the printer paper in a desired size that is supported by the printer.

On the other hand, the web pages do not have same capabilities as of the client side applications and are not allowed to interact with the client computer of the host system and the printer. This is due to the reason that, in order to establish an interaction between the web pages and the host system and/or the printer, the web browser of the host system may need to communicate with a malicious host (malicious client side script of the web pages) related to the web pages. This malicious host can infect an internal system of the client computer and propagate the Malware. Thus, there is a necessity for imposing security limitation for the web page. Due to this, the web browser operates in an environment that prevents interaction with the OS and peripherals such as the printer unless a browser extension is installed at the host system.

Due to aforementioned, the web pages do not have knowledge of the printer paper that can be supported by the printer, or other printer capabilities and printer settings. Therefore, the web page may be rendered for a few common sizes of the printer paper, resulting in exclusion of other feasible sizes of the printer paper as well as an inefficient usage of space on the printer paper. Furthermore, the web page may not directly enable features of the printer's driver, which might result in inferior output from the print operation.

Based on the foregoing, there is a need for providing an interaction between a host syste and web pages in a Wide Area Network. Further, the web pages should be able to interact with the host system for accessing the features of a peripheral device present at the host system, such as the features of a printer driver or size of a printer paper in order to optimize the print operation of the web pages. The print operation should be optimized in a way to avoid any wastage of the printer paper or ink/toner of the printer. Further, there is a need to establish the interaction, between the host system and the web pages, without compromising with the security of the web browser.

### SUMMARY OF THE DISCLOSURE

In view of the foregoing disadvantages inherent in the prior art, the general purpose of the present disclosure is to provide a method and systems for providing interaction between a host system of a client side and a plurality of web pages in a Wide Area Network to include all the advantages of the prior art, and to overcome the drawbacks inherent therein.

In one aspect, the present disclosure provides a method for providing interaction between a host system and a plurality of web pages in a Wide Area Network. The method is performed at the host system. The method includes receiving a request from a web page of the plurality of web pages for information of a peripheral device. The peripheral device is associated with the host system. The method further includes creating an iframe element of the web page. The iframe element includes a Uniform Resource Indicator (URI) of an actual script file for the web page. Further, the method includes extracting a serialized form of the request based on a navigation event corresponding to the iframe element of the web page. The navigation event is triggered by a web browser of the host system. Further, the method includes generating a response attribute corresponding to the request based on the serialized form of the request. Furthermore, the method includes providing the response attribute to the iframe element of the web page.

In another aspect, the present disclosure provides a system for providing interaction between a host system and a plurality of web pages in a Wide Area Network. The system includes an Application Programming Interface (API) system and a browser extension communicably coupled to the API system. The API system is configured to receive a request for information of a peripheral device associated with the host system. The request is received from a web page of the plurality of web pages. The API system is further configured to create an iframe element of the web page. The iframe element includes a Uniform Resource Indicator (URI) of an actual script file for the web page. The browser extension is configured to extract a serialized form of the request based on a navigation event corresponding to the iframe element of the web page. The navigation event is triggered by a web browser of the host system. The browser extension is further configured to generate a response attribute corresponding to the request based on the serialized form of the request. Further, the system is configured to provide the response attribute to the iframe element of the web page.

In yet another aspect, the present disclosure provides a host system. The host system includes a peripheral device, a web browsing module, an Application Programming Interface (API) system and a browser extension communicably coupled to the API system. The web browsing module is configured to access a plurality of web pages in a Wide Area Network. The API system is configured to receive a request for information of a peripheral device. The peripheral device is associated with the host system and the request is received from a web page of the plurality of web pages. The API system is further configured to create an iframe element of the web page. The iframe element includes a Uniform Resource Indicator (URI) of an actual script file for the web page. The browser extension is configured to extract a serialized form of the request based on a navigation event corresponding to the iframe element of the web page. The navigation event is triggered by the web browsing module. Further, the browser extension is configured to generate a response attribute corresponding to the request based on the serialized form of the request. Furthermore, the browser extension is configured to provide the response attribute to the iframe element of the web page.

### BRIEF DESCRIPTION OF THE DRAWINGS

The above-mentioned and other features and advantages of this disclosure, and the manner of attaining them, will become more apparent and the disclosure will be better understood by reference to the following description of embodiments of the disclosure taken in conjunction with the accompanying drawings, wherein:

FIG. 1 illustrates an exemplary network, according to one embodiment of the present disclosure;

FIG. 2 is an exemplary block diagram illustrating an interaction between a host system and a plurality of web pages, according to one embodiment of the present disclosure;

FIG. 3 illustrates an exemplary flowchart of a method for interaction between a host system and a plurality of web pages, embodying the present disclosure; and

FIG. 4 illustrates another exemplary flowchart of a method for interaction between a host system and a plurality of web pages, embodying the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the telins “connected” and “coupled” and variations thereof are not restricted to physical or mechanical connections or couplings.

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the disclosure may be implemented in a software. As such, it should be noted that a plurality of hardware and software-based devices, as well as a plurality of different structural components may be utilized to implement the present disclosure.

The present disclosure provides a method and a system for providing interaction between a host system and a plurality of web pages in a Wide Area Network. The Wide Area Network enables World Wide Web (hereinafter referred to as “web”) such as Internet. The host system is present on a client side of the web that may include various devices such as a client computer, peripheral devices attached to the client computer, such as a printer, a scanner and the like. The present disclosure provides a way to render information related to the peripheral devices of the host system (hereinafter referred to as “the information”) to the web pages by the way of querying the host system. For example, a web page may request the host system for the information related to a peripheral device, such as a printer, of the host system. The method and the system may receive a request from the web page for the information. Conventionally, the web page is not allowed to access the host system for the information for the sake of retaining a necessary security level for the host system; however, the method and the system provide mechanism to provide the information to the web page while maintaining a security level for the host system.

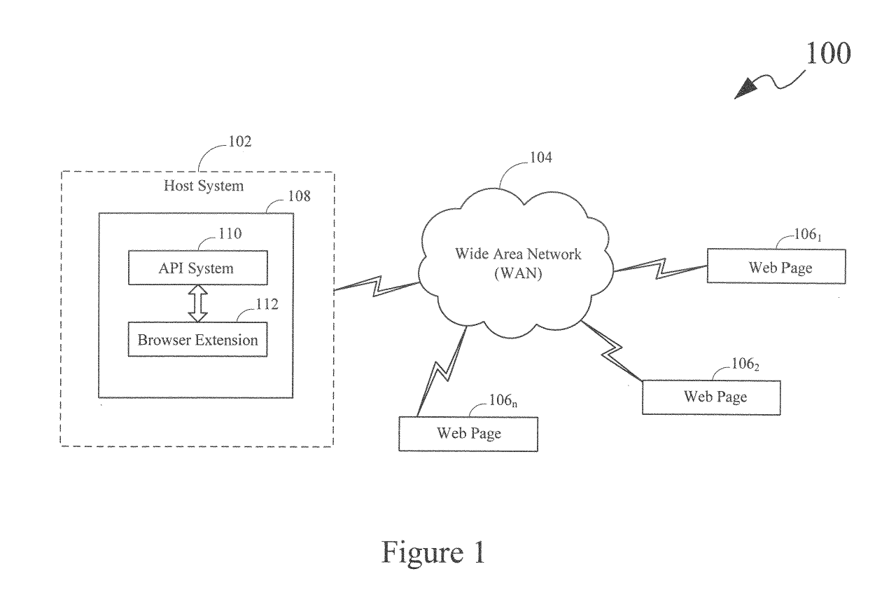

Referring now to the drawings and particularly to FIG. 1, an exemplary diagram of a network 100 is shown, according to one embodiment of the present disclosure. Network 100 includes a host system 102, a Wide Area Network 104 (hereinafter referred to as ‘WAN 104’) and a plurality of web pages such as a web page 106₁, a web page 106₂, and a web page 106ₙ (hereinafter referred to as ‘web pages 106’). Host system 102 and web pages 106 may interact through WAN 104. Host system 102 broadly includes a system 108 capable of providing interaction between host system 102 and web pages 106 through WAN 104. System 108 includes an Application Programming Interface (API) system 110 and a browser extension 112.

System 108 may receive a request regarding the information of the peripheral device of host system 102, from a web page, such as a web page 106₁. Further, system 108 is configured to access the information, corresponding to the request, from host system 102. System 108 is further configured to provide the information to web page 106₁. For example, system 108 may receive a request from web page 106₁, for the information of a printer (not shown) that may be present at host system 102. The printer may be attached to a client computer (not shown) of host system 102.

Herein, the term ‘information’ of a peripheral device may refer to, but is not restricted to, type of the peripheral device, a configuration of the peripheral device, capability of the peripheral device, status of the peripheral device, and driver setting of the peripheral device. The type of the peripheral device may refer to information related to manufacture of the peripheral device. The configuration of the peripheral device represents information related to hardware modules of the peripheral device. Further, the capability and the status of the peripheral device such as the printer may include, but are not restricted to, size of a printer media supported by the printer, active/inactive status of the printer, cartridge information, such as ink level, of the printer. The driver setting of the peripheral device may refer to information related to a software module that is utilized to operate the peripheral device.

API system 110 may provide a library of functions to web page 106₁ and provide a simple and consistent interface that may allow web page 106₁ to make an asynchronous request (hereinafter referred to as ‘request’) to host system 102. Further, API system 110 may create an iframe element of the web page. The iframe element may include a Uniform Resource Indicator (URI) of an actual script file of the web page. Without departing from the scope of the present disclosure, browser extension 112 may be a web browser specific module installed on the client computer of host system 102 and is communicably coupled to API system 110. Browser extension 112 may detect the request (of web page 106₁) from API system 110 and may evaluate the request by communicating with the web browser and an Operating System (OS) of the client computer for providing the information to web page 106₁.

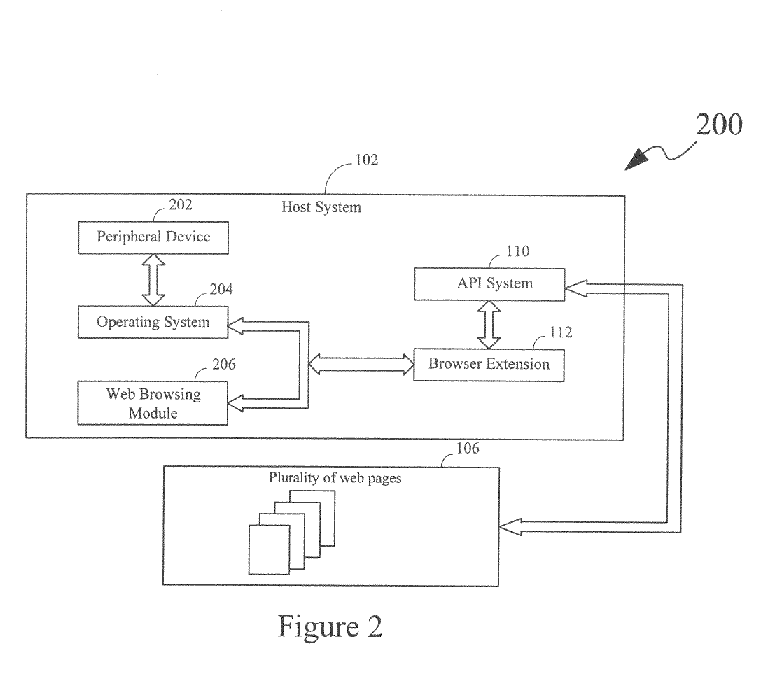

Referring now to FIG. 2, an exemplary block diagram 200 illustrating an interaction between a host system such as host system 102 and web pages 106, is shown, according to one embodiment of the present disclosure. FIG. 2 depicts various components of host system 102 including an API system such as API system 110, a browser extension such as browser extension 112 and a peripheral device 202. Host system 102 further includes an OS 204 and a web browsing module 206. Browser extension 112 is communicably coupled to API system 110 as explained in conjunction with FIG. 1. Browser extension 112 is linked with OS 204 and web browsing module 206. OS 204 and web browsing module 206 may be present at a client computer (not shown) of host system 102.

Peripheral device 202 may include, but is not restricted to, a printer coupled to the client computer of host system 102, or a printer having OS installed on it. Peripheral device 202 is hereinafter, referred to as “the printer” for the sake of clarity of the present disclosure. Web browsing module 206 includes a browser to display web pages 106 onto the client computer of host system 102. Web browsing module 206 offers a unique set of options for printing of a web page, such as web page 106₁. The unique set of options may include, but is not limited to, a size of the printer media, options related to settings of headers and footers of the web page, and portrait orientation of the printer media. However, the unique set of options may not be compatible with the printer of host system 102. Moreover, web browsing module 206 restricts web page 106₁ to access OS 204 and hence the printer. Browser extension 112 may be installed on the client computer of host system 102 and is specific to web browsing module 206 of host system 102.

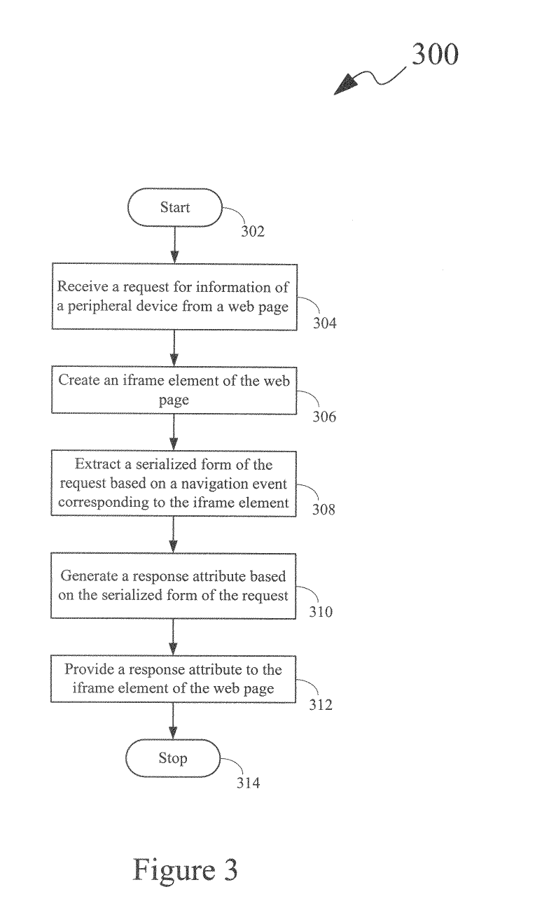

Web page 106₁ may query the information of the printer by sending request to API system 110. Browser extension 112 may detect the request from API system 110 and may handle the request by interacting with OS 204 and web browsing module 206. Browser extension 112 may access the information of the printer, through an interaction with OS 204 and web browsing module 206, corresponding to the request for the information. Further, browser extension 112 may generate a response attribute corresponding to the request and provide the response attribute to the web page. The present disclosure further provide methods to provide interaction between host system 102 and web pages 106, which is further described in conjunction with FIG. 3.

Referring now to FIG. 3, an exemplary flowchart of a method 300 for providing interaction between a host system and a plurality of web pages is shown, embodying the present disclosure. Method 300 is performed at the host system, such as host system 102. Method 300 may be clearly understood based on the foregoing explanation in conjunction with FIG. 1 and FIG. 2. The order, in which method 300 is described herein, should not be construed as a limitation, and any number of the described method blocks may be combined in any order to implement method 300, or an alternative method.

Method starts at block 302. At block 304, a request for information of a peripheral device, such as peripheral device 202 is received at host system 102. The request is received from a web page of web pages 106. The peripheral device may include, but is not restricted to, a printer. The web page may request for the information by utilizing a library of functions of an API system, such as API system 110 of host system 102. As explained in conjunction with FIG. 1, the information may be related to type of the printer, a configuration of the printer, capability of the printer, status of the printer, and driver setting of the printer. For example, the API system may receive a request related to current ink level of the printer, a default printer available at the host system, size of a printer paper that is suitable for the default printer, and the like. The web page may request the information of the printer for adjusting the web page based on the information and thereby to achieve efficient print operation of the web page.

In one embodiment of the present disclosure, the web page may make a request by using a JavaScript code that may include a single void ( ) method call with a single parameter. The void ( ) method call is a valid, non executing JavaScript method that may store the request of the web page. The single parameter is an object that may represent the request of the web page in the void ( ) method. The single parameter (representing the request of the web page) in the void ( ) method call may be in a form as follows:
“call”:“% CALL %”
   Herein, “% CALL %” may refer to a name of the request of the web page. The request may be followed by optional set of parameters to represent the request. An exemplary syntax for the request and the optional set of parameters may be as follows:
% request %?% param1%=% value1% & % param2%=% value2%
   Herein, “% request %” represents name of the request made by the web page, and “param1”and “param2” may be the optional set of parameters (hereinafter referred to as “the optional parameters”) of the request. The optional parameters may be included in the syntax of the request based on a particular request. For example, when the web page needs to request for ink level of the default printer that may be the optional parameters, the web page may send the request by providing two optional parameters, such as a first optional parameter related to the default printer and a second optional parameter related to the ink level for the default printer. Further, “value1%” and “value2%”, in the syntax, may represent values corresponding to the optional parameters “param1”and “param2” respectively. Sign “?” in the syntax may be used to delimit between the name of the request and the optional parameters. Further, it may be apparent to those skilled in the art that each of the optional parameters (with a value of the parameter) may be delimited by using “&” as delimiter. It would also be apparent to those skilled in the art that sending the request may follow the common URI query scheme in RFC 3986.

In an example, the web page may request for the ink level of the “X” printer by making the request in the following form:
“call”:“getprinterinkpercentage?friendly=X&type=C
   Herein, “getprinterinkpercentage” represents the name of the request. Further, terms “friendly” and “type” may be optional parameters corresponding to the request. For example, “friendly” denotes the default printer and “type” denotes the type of the ink of the default printer. “X” and “C” are values corresponding to the optional parameters, “friendly” and “type”, respectively. Herein, “X” represents the name of the default printer and “C” represents the type of the ink, such as colored ink of the default printer “X”. This format of the request is only an exemplary request of the web page for the ink level of the colored ink of the default printer “X”, and should not be construed as a limitation on the syntax for the request of the web page.

Additionally, the web page may request for printing with a particular printer setting. The printer setting may include various print options that may be configured by the web page. The web page may configure the various print options that may include, but are not restricted to, headers/footers and margin, portrait, landscape, paper size, and the like. For example, the request for the print operation may be of the following form:

void ( {“id”:”%ID%”, “call”:”print?headerfooter=0&marginleft-
0&marginright=0&margintop=0&marginbottom=0&friendly=X”} );

Herein, the request is for the print operation where “headerfooter” is one of the optional parameters for adjusting header and footer of the web page to ‘0’. Similarly “marginleft”, “marginright”, “margintop” and “marginbottom” are the optional parameters for adjusting left, right, top and bottom margins of the web page, respectively. Further, friendly=X represents that the default printer is “X”.

After the request is received at block 304, method 300 creates an invisible iframe element (hereinafter referred to as “the iframe element”) of the web page at block 306. In one embodiment of the present disclosure, the iframe element is created in a Document Object Model (DOM) of the web page. The iframe element includes the URI that may represent an actual file or script (hereinafter referred to as “actual script file”) of the web page on a web server. Typically, the web server communicates with hypertext transfer protocol (HTTP) so the URI may begin with “http:”.

Further, method 300 utilizes the iframe element through the JavaScript code. The JavaScript code may use “JavaScript:” as a pseudo-protocol that may be treated as the prefix to JavaScript code by the web browser. The JavaScript code may be packaged as a target of the iframe element. The pseudo-protocol may be represented as follows:
javaScript: void ({“id”:“% ID %”, “call”:“% CALL %”})
   Herein, the pseudo-protocol (“JavaScript:”) represents “% ID %” and “% CALL %” in the void ( ) method call. Term “% ID %” corresponds to the iframe element's identification attribute value that includes the actual script file for the web page. Further, “% CALL %” is the request received from the web page.

Further, a web browsing module, such as web browsing module 206 (hereinafter referred to as “the web browsing module”) may trigger a navigation event on execution of the pseudo-protocol, The navigation event may include navigation to the actual script file based on the iframe element. The navigation event of the web browsing module may be trapped by a browser extension, such as browser extension 112. The navigation event may assist the browser extension in determining a source of the navigation.

At block 308, method 300 extracts a serialized form of the request. The serialized form of the request may be extracted by the browser extension by trapping the navigation event. The browser extension may know about the request of the web page from the source of the navigation event by trapping the navigation event and further, the browser extension may extract the serialized form of the request. The serialized form of the request may be called as “JavaScript Object Notation (JSON)”.

At block 310, method 300 generates a response attribute based on the serialized form of the request. Method 300 may utilize the browser extension for generating the response attribute. The serialized form of the request may be evaluated (by the browser extension) for generating the response attribute for the request. In one embodiment, the serialized form of the request may be evaluated by utilizing a library corresponding to the serialized form of the request. The library may be called as a JSON library. In another embodiment, the serialized form of the request may be evaluated by regular expression matching of the serialized form of the request to a set of valid options. The set of valid options may correspond to the printer and may be supported by an OS, such as OS 204 of the host system, and the web browsing module. A person skilled in the art would appreciate that method 300 maintains the safety of an environment of the web browsing module by not executing the request directly like a script or SQL query, but by evaluating the serialized form of the request by matching the serialized form of the request with the set of valid options.

Further, in one embodiment, method 300 may query the serialized form of the request to at least one of the OS and the web browsing module for generating the response attribute, when the serialized form of the request matches with at least one of the set of valid options. In another embodiment, method 300 may generate an invalid response code as the response attribute from the browser extension when the serialized form of the request does not match with at least one of the set of valid options. In another embodiment, when the OS is Windows®, method 300 may call a Graphic Device Interface (GDI) subsystem (hereinafter referred to as “the GDI”). When the OS is Windows®, the OS generally includes the GDI for maintaining the printer's setting, capability and status, such as the printer media supported by the printer, driver name, online status and printing status of the printer. Method 300 may call the GDI for obtaining information corresponding to the serialized form of the request for generating the response attribute. For example, method 300 may obtain a list of installed printers in the host system, read values from a Windows® registry, and the like by calling the GDI.

Further at block 312, method 300 may provide the response attribute to the iframe element by accessing the iframe element in the web page's DOM. A value of the response attribute may include a serialized object that may be of the following form:
{“status”:“% STATUS %”, “result”:% RESULT %}
   Here, % STATUS % may indicate the status of the request of the web page that may include, but is not restricted to, information such as the request of the web page has been processed successfully, failed, and was invalid.
   % RESULT % may indicate the response attribute that may include an array of return value corresponding to the request.

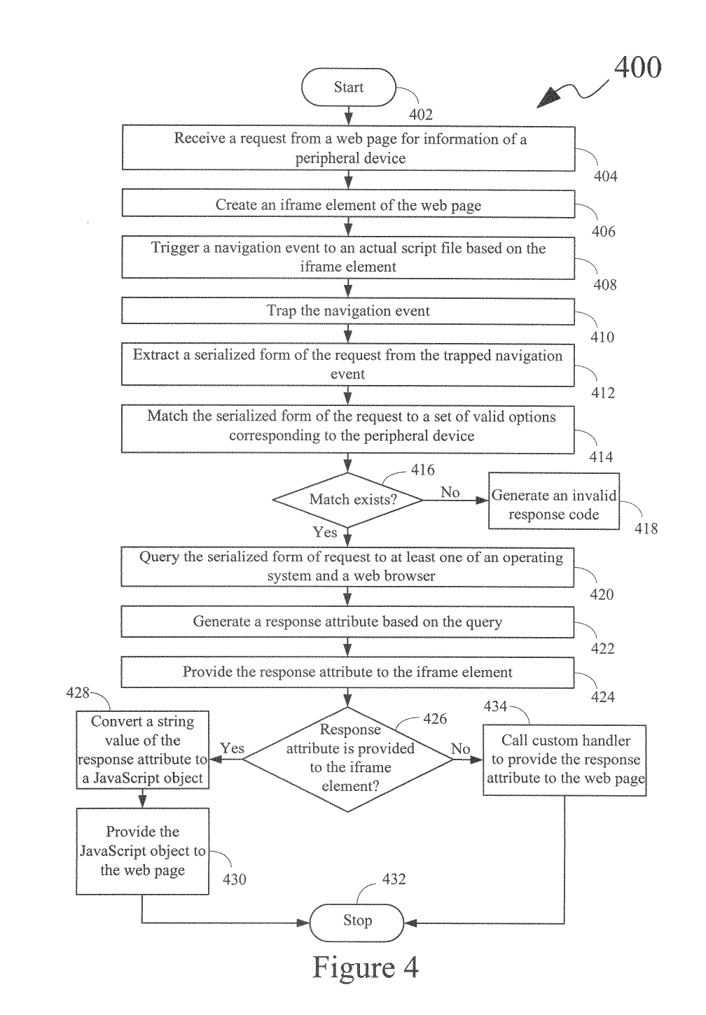

Thereafter, method 300 for providing interaction between the host system and the web pages is terminated at block 314. The present disclosure further provides another method for providing interaction between the host system and the web pages, which is described in detail in conjunction with FIG. 4.

Referring now to FIG. 4, an exemplary flowchart of a method 400 for providing interaction between a host system and a plurality of web pages is shown. The description of FIG. 4 may be understood based on the foregoing explanation in conjunction with FIGS. 1, 2 and 3. The order in which method 400 is described is not intended to be construed as a limitation, and any number of the described method blocks may be combined in any order to implement method 400, or an alternative method.

Method 400 starts a block 402. At block 404, method 400 receives a request from a web page for information of a peripheral device such as a printer (hereinafter referred to as “the printer”). As explained in conjunction with FIG. 3, the information may be related to type of the printer, a configuration of the printer, capability of the printer, status of the printer, and driver setting of the printer. The web page may make a request by using a JavaScript code that may include a single void ( ) method call.

At block 406, an iframe element of the web page is created. As explained in conjunction with FIG. 3, the iframe element includes a URI of an actual script file for the web page. In one embodiment, the iframe element may be packaged in the void ( ) method call (that includes the request) of the JavaScript code. Block 404 and 406 are performed similar to blocks 304, 306, respectively, as described in conjunction with FIG. 3, and hence are not described again in detail, for the sake of brevity.

At block 408, method 400 triggers a navigation event to the actual script file of the web page. The navigation event may correspond to the iframe element of the void( ) method call and may be triggered by execution of the JavaScript code. The navigation event may assist a browser extension, such as browser extension 112, in determining a source of the navigation event. Further, at block 410, the navigation event is trapped by a browser extension, such as browser extension 112. Method 400 further extracts a serialized form of the request at block 412, after trapping the navigation event by the browser extension. Blocks 408, 410, and 412 are performed similar to blocks 306 and 308 of FIG. 3 and hence are not described again for the sake of brevity.

At block 414, the serialized form of the request is matched to a set of valid options corresponding to the printer. The set of valid options are supported by an OS and a web browsing module, such as web browsing module 206, of the host system.

At block 416, it is determined whether the serialized form of the request matches with the set of valid options. If the serialized form of the request does not match with the set of valid options, then method 400 proceeds to block 418 (shown by the “No” branch from block 416). Further, if the serialized form of the request matches with the set of valid options, method 400 proceeds to block 420 (shown by the “Yes” branch from block 416).

At block 418, method 400 generates an invalid response code. The invalid response code may indicate that the serialized form of the request does not match with the set of valid options. Due to this, settings of the web page may not be adjusted according to the printer's settings for an efficient print operation of the web page,

At block 420, method 400 may query the serialized form of the request to at least one of the OS and the web browsing module. The query may be for obtaining the information related to the printer. In one embodiment, method 400 may call the GDI for obtaining information corresponding to the serialized form of the request. Method 400 may call the GDI when the OS supports the GDI for maintaining the printer's capabilities and status of the printer. The GDI may include, but not restricted to, the information related to the printer's capability and status such as supported size of printer media for the printer, driver's name, online status and printing status of the printer. For example, the Windows® OS has a GDI subsystem that may be used to provide a basic rendering of the printer media in any size that may be supported by the printer. Thus, the GDI may be called for obtaining the information corresponding to the serialized form of the request and in such case, method 400 may not require querying the serialized form of the request to the OS and the web browsing module.

At block 422, the information, obtained from the query, corresponding to the printer may be utilized by the browser extension for generating the response attribute corresponding to the request of the web page. The method may generate the response attribute based on the information and value of the response attribute may be a serialized object of the following form:
{“status”:“% STATUS %”, “result”:% RESULT %}
   Herein, % STATUS % may indicate the status of the request of the web page that may include, but not restricted to, information such as the request of the web page has been processed successfully, failed, and was invalid.
   % RESULT % may indicate the response attribute that may include an array of return value corresponding to the request.

At block 426, it is determined whether the response attribute is provided to the iframe element. An API system such as API system 110, may poll the iframe element for the response attribute until the response attribute is provided to the iframe element. If it is determined that the response attribute is provided to the iframe element, method 400 proceeds to block 428 (shown by the “Yes” branch from block 426).

At block 428, method 400 may convert a string value of the response attribute to a JavaScript object and at block 430, the JavaScript object may be provided to the web page. In an embodiment, the JavaScript object may be provided to a custom handler of the web page. Thereafter method 400 is terminated at block 432.

Further, from block 426, method 400 may proceed to block 434 (shown by the “No” branch from block 426), if it is determined that the response attribute is not provided to the iframe element. At block 434, the API system may call the custom handler of the web page automatically, if the browser extension does not respond or provide the response attribute to the iframe element with an acceptable amount of time (that may be predefined). The custom handler may be called with a “timeout” status that may represent that the response attribute is not provided to the iframe element within the acceptable amount of time. A person skilled in the art would appreciate that such automatic call to the custom handler may guarantee that the web page will receive the response attribute for the request. Further, it may be pertinent to know that method 400 may further perform any operation that may guarantee that the response attribute is received at the web page and may not be restricted to the automatic call to the custom handler. After the block 434, method 400 is terminated at the block 432.

It may be apparent to those skilled in the art that the present disclosure is not restricted to functions and operations of systems such as systems 102 and 108 and methods such as methods 300 and 400 as explained above. Various blocks of the methods and various components of the systems may be implemented beyond the scope of this disclosure to serve the purpose of the present disclosure. The present disclosure has been explained by considering “printer” as the peripheral device for the sake of establishing clarity in understanding the present disclosure. However, the peripheral device is not restricted to the printer and may include a device that may be present at the host system and may be capable of communicating with the OS of the host system.

The foregoing description of several methods and an embodiment of the disclosure have been presented for purposes of illustration. It is not intended to be exhaustive or to limit the disclosure to the precise steps and/or forms disclosed, and obviously many modifications and variations are possible in light of the above description. It is intended that the scope of the disclosure be defined by the claims appended hereto.

What is claimed is:

1. A method for providing interaction between a host system and a plurality of web pages in a Wide Area Network, the method performed at the host system, the method comprising:
receiving a request for information of a peripheral device associated with the host system, the request received from a web page of the plurality of web pages;
creating an iframe element of the web page, the iframe element comprising a Uniform Resource Indicator (URI) of an actual script file for the web page;
extracting a serialized form of the request based on a navigation event corresponding to the iframe element of the web page, the navigation event triggered by a web browser of the host system;
generating a response attribute corresponding to the request based on the serialized form of the request; and
providing the response attribute to the iframe element of the web page.

2. The method of claim 1, wherein the information comprises at least one of a type, capability, a state, a configuration and a driver setting of the peripheral device.

3. The method of claim 1, wherein the iframe element is created in a Document Object Model (DOM) of the web page.

4. The method of claim 1, wherein the navigation event is triggered for accessing the actual script file for the web page based on the iframe element, and wherein the serialized form of the request is received by trapping the navigation event.

5. The method of claim 1, wherein generating the response attribute comprises:
evaluating the serialized form of the request by matching the serialized form of the request to a set of valid options corresponding to the peripheral device, the set of valid options supported by at least one of an Operating System of the host system and the web browser of the host system; and
querying the serialized form of the request to at least one of the Operating System and the web browser for generating the response attribute, the at least one of the Operating System and the web browser queried when the serialized form of the request matches

6. The method of claim 1, wherein generating the response attribute comprises:
evaluating the serialized form of the request by matching the serialized form of the request to a set of valid options corresponding to the peripheral device, the set of valid options supported by at least one of an Operating System of the host system and the web browser of the host system; and
accessing a Graphics Device interface (GDI) of the Operating System of the host system for accessing the information to generate the response attribute, when the serialized form of the request matches with at least one valid option of the set of valid options.

7. The method of claim 1 further comprising:
determining a presence of the response attribute in the iframe element of the web page, the response attribute comprising a string value;
converting the string value of the response attribute into a JavaScript object based on the determination of the presence of the response attribute; and
providing the JavaScript object to the web page.

8. The method of claim 7, wherein the JavaScript object is provided to a custom handler of the web page.

9. The method of claim 1, wherein generating the response attribute comprises generating an invalid response code when the serialized form of the request is unmatched to at least one valid option of a set of valid options corresponding to the peripheral device, the set of valid options supported by at least one of an Operating System of the host system and the web browser of the host system.

10. A system for providing interaction between a host system and a plurality of web pages in a Wide Area Network, the system comprising:
an Application Programming Interface (API) system configured to
receive a request for information of a peripheral device associated with the host system, the request received from a web page of the plurality of web pages, and
create an iframe element of the web page, the iframe element comprising a Uniform Resource Indicator (URI) of an actual script file for the web page; and
a browser extension communicably coupled to the API system, the browser extension configured to
extract a serialized form of the request based on a navigation event corresponding to the iframe element of the web page, the navigation event triggered by a web browser of the host system,
generate a response attribute corresponding to the request based on the serialized form of the request, and
provide the response attribute to the iframe element of the web page.

11. The system of claim 10, wherein the information comprises at least one of a type, capability, a state, a configuration and a driver setting of the peripheral device.

12. The system of claim 10, wherein the iframe element is created in a Document Object Model (DOM) of the web page.

13. The system of claim 10, wherein the navigation event is triggered for accessing the actual script file for the web page based on the iframe element, and wherein the serialized form of the request is received by trapping the navigation event.

14. The system of claim 10, wherein the browser extension is configured to evaluate the request by:
evaluating the serialized form of the request by matching the serialized form of the request to a set of valid options corresponding to the peripheral device, the set of valid options supported by at least one of an Operating System of the host system and the web browser of the host system; and
querying the serialized form of the request to at least one of the Operating System and the web browser for generating the response attribute, the at least one of the Operating System and the web browser queried when the serialized form of the request matches with at least one valid option of the set of valid options.

15. The system of claim 10, wherein the browser extension is further configured to evaluate the request by:
evaluating the serialized form of the request by matching the serialized form of the request to a set of valid options corresponding to the peripheral device, the set of valid options supported by at least one of an Operating System at the host system and the web browser of the host system; and
accessing a Graphics Device interface (GDI) of the Operating System for accessing the information to generate the response attribute, when the serialized form of the request matches with at least one valid option of the set of valid options.

16. The system of claim 10, wherein the API system is further configured to:
determine a presence of the response attribute in the iframe element of the web page, the response attribute comprising a string value;
convert the string value of the response attribute into a JavaScript object based on the determination of the presence of the response attribute; and
provide the JavaScript object to the web page.

17. The system of claim 16, wherein the JavaScript object is provided to a custom handler of the web page.

18. The system of claim 10, wherein the browser extension is further configured to generate the response attribute as an invalid response code when the serialized form of the request is unmatched to at least one valid option of a set of valid options corresponding to the peripheral device, the set of valid options supported by at least one of an Operating System of the host system and the web browser of the host system.

19. A host system comprising:
a peripheral device;
a web browsing module configured to access a plurality of web pages in a Wide Area Network;
an Application Programming Interface (API) system configured to
receive a request for information of a peripheral device associated with the host system, the request received from a web page of the plurality of web pages, and
create an iframe element of the web page, the iframe element comprising a Uniform Resource Indicator (URI) of an actual script file for the web page; and
a browser extension communicably coupled to the API system, the browser extension configured to
extract a serialized form of the request based on a navigation event corresponding to the iframe element of the web page, the navigation event triggered by the web browsing module,
generate a response attribute corresponding to the request based on the serialized form of the request, and
provide the response attribute to the iframe element of the web page.

20. The host system of claim 19, wherein the information comprises at least one of a type, capability, a state, a configuration and a driver setting of the peripheral device;

21. The host system of claim 19, wherein the iframe element is created in a Document Object Model (DOM) of the web page.

22. The host system of claim 19, wherein the navigation event is triggered for accessing the actual script file for the web page based on the iframe element, and wherein the serialized form of the request is received by trapping the navigation event.

23. The host system of claim 19, wherein the browser extension is configured to evaluate the request by:
evaluating the serialized form of the request by matching the serialized form of the request to a set of valid options corresponding to the peripheral device, the set of valid options supported by at least one of an Operating System at the host system and the web browsing module; and
querying the serialized form of the request to at least one of the Operating System and the web browsing module for generating the response attribute, the at least one of the Operating System and the web browsing module queried when the serialized form of the request matches with at least one valid option of the set of valid options.

24. The host system of claim 19, wherein the browser extension is further configured to evaluate the request by:
evaluating the serialized form of the request by matching the serialized form of the request to a set of valid options corresponding to the peripheral device, the set of valid options supported by at least one of an Operating System at the host system and the web browsing module; and
accessing a Graphics Device interface (GDI) of the Operating System for accessing the information to generate the response attribute, when the serialized form of the request matches with at least one valid option of the set of valid options.

25. The host system of clan 19, wherein the API system is further configured to:
determine a presence of the response attribute in the iframe element of the web page, the response attribute comprising a string value;
convert the string value of the response attribute into a JavaScript object based on the determination of the presence of the response attribute; and
provide the JavaScript object to the web page.

26. The host system of claim 25, wherein the actual JavaScript object is provided to a custom handler of the web page.

27. The host system of claim 19, wherein the browser extension is further configured to generate the response attribute as an invalid response code when the serialized form of the request is unmatched to at least one valid option of a set of valid options corresponding to the peripheral device, the set of valid options supported by at least one of an Operating System at the host system and the web browsing module.
